(19) United States
(12) Patent Application Publication
(10) Pub. No.: US 2012/0173410 A1
(43) Pub. Date: Jul. 5, 2012

(54) SYSTEM AND METHOD FOR PAYING CITATIONS USING SMS TEXT MESSAGING

(75) Inventor: Matthew J. Gillin, Villanova, PA (US)

(73) Assignee: RELAY HOLDINGS, LLC, Radnor, PA (US)

(21) Appl. No.: 12/983,764

(22) Filed: Jan. 3, 2011

(51) Int. Cl. G06Q 20/00

(52) U.S. Cl. 705/39

(57) ABSTRACT

A system and method are provided for enabling the recipient of a citation to pay the associated fine using SMS text messaging. The system includes a server platform programmed to receive an SMS text from a customer, the SMS text including a citation number, a unique identifier for the municipality that issued the citation, and an RFID transponder number and/or a license plate number for the customer that is linked to a payment device, such as a credit card account. Upon receipt of the SMS text, the server platform validates the citation number and municipality unique identifier against a citation database, charges a percentage of the amount of the citation to the payment device linked to the RFID transponder number or license plate number (e.g., a credit or debit account on file), and transfers payment of the percentage of the citation amount to the municipality identified by the unique identifier. The server platform also sends confirmation of payment of the citation to the customer via an SMS text message. The server platform extracts a processing fee for processing payment of the citation.

### FIELD OF THE INVENTION

The present invention relates to an electronic system and method that enables electronic payment of citations and, more particularly, to a system and method for enabling a person who has received a citation, such as a traffic ticket, to pay the citation using SMS text messaging and to credit the authority that issued the citation with the payment.

### BACKGROUND

Authorities that issue citations such as traffic tickets, parking tickets, public health citations, and the like have notoriously difficult times collecting the associated fines. Enforcement efforts are costly and cumbersome and are highly unpopular. While electronic payment systems are relatively efficient and have long been used, such systems do not enable the person receiving the citation to pay the citation at the time he/she is most likely to pay, namely, at the time the citation is received. A better payment mechanism is desired that will make payment of citations fast and easy for the issuing authority and that will also make enforcement efforts more efficient for the issuing authority.

It is desired to provide an electronic payment system that takes advantage of the ubiquity of cell phones and, in particular, the medium of SMS text messaging, to enable the immediate payment of fines associated with citations. This medium can be used to maximum effect because it enables the issuing authority to provide incentives in the form of discounts to the recipient of a citation to pay the associated fines immediately. The present invention provides a system platform and method for such an SMS text messaging payment system.

### SUMMARY

Systems and methods are provided for enabling the recipient of a citation to pay the associated fine using SMS text messaging. The system includes a server platform programmed to receive an SMS text from a customer, the SMS text including a citation number, a unique identifier for the municipality that issued the citation, and a transponder ID number and/or a license plate number for the customer that is linked to a payment device, such as a credit card account. Upon receipt of the SMS text, the server platform validates the citation number and municipality unique identifier against a citation database, charges a percentage of the amount of the citation to the payment device linked to the transponder ID number or license plate number (e.g., a credit or debit account on file), and transfers payment of the percentage of the citation amount to the municipality identified by the unique identifier. The server platform also sends confirmation of payment of the citation to the customer via an SMS text message. In an exemplary embodiment, the percentage of the amount of the citation is less than 100% as the server platform extracts a processing fee for processing payment of the citation.

In exemplary embodiments, the citation may be paid using an RFID transponder tied to a credit or debit account or directly by linking the RFID transponder number and/or license plate number for the customer to the customer's credit card or debit card. Upon receipt of electronic payment by the server platform, the electronic payment is processed in the conventional manner and payment is distributed to the municipality designated by the municipality unique identifier.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Exemplary embodiments of the invention will be described in connection with the associated figures, of which:

FIG. 1 illustrates an example embodiment of a citation settlement system for enabling electronic payment of citations using SMS text messaging and to credit the authority that issued the citation with the payment.

FIG. 2 illustrates an example embodiment of a method implemented by the communications platform for enabling a person who has received a citation to attend to payment of any fines associated with the citation using SMS text messaging.

FIG. 3 illustrates the operation of the embodiment of FIGS. 1 and. 2 in more detail, including payment of the municipality that issued the citation.

### DETAILED DESCRIPTION OF ILLUSTRATIVE EMBODIMENTS

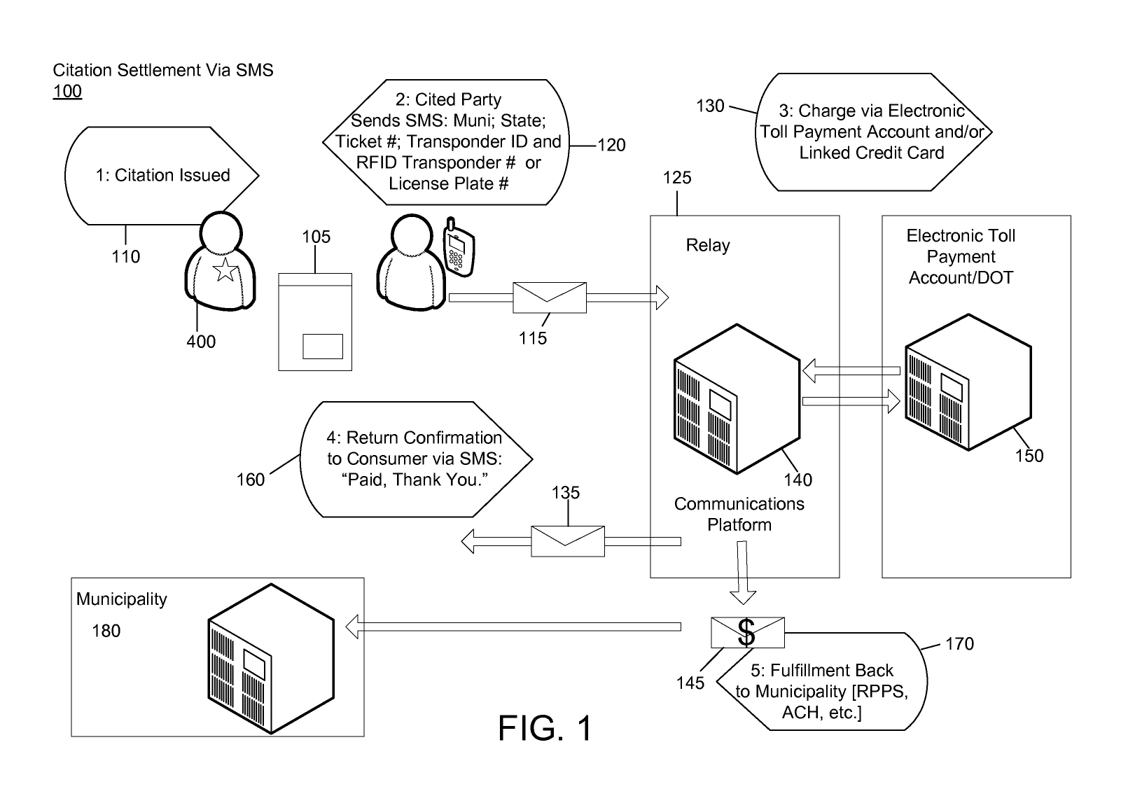

A detailed description of illustrative embodiments of the present invention will now be described with reference to FIGS. 1-3. Although this description provides a detailed example of possible implementations of the present invention, it should be noted that these details are intended to be exemplary and in no way delimit the scope of the invention.

FIG. 1 illustrates an example embodiment of a citation settlement system 100 for enabling electronic payment of citations using SMS text messaging and to credit the authority that issued the citation with the payment. As illustrated, a citation 105 is issued to a cited party 300 by an issuing officer 400 at step 110. The cited party 300 is provided an option to send an SMS text message 115 to a communications platform 125 at step 120 as illustrated. In an exemplary embodiment, the cited party is motivated to pay any fine associated with the citation right away in order to save a percentage of the fine. The SMS text message 115 preferably includes a unique ID identifying the municipality and/or state organization (“issuing authority”) that issued the citation, the citation (ticket) number, and a license plate number and/or an RFID transponder for an RFID system of the cited party that is linked to a payment mechanism, such as credit or a debit account, for payment. Rather than providing the RFID transponder number or license plate number, the cited party could alternatively provide credit card or debit card information or other identifying information that links the cited party to a payment system. On the other hand, if no payment information is linked to the customer's identifying information (license plate number or RFID transponder number), then the cited party may be instructed to send an SMS text message to server 140 of the communications platform 125 indicating that no payment information is available for the cited party. The server 140 may then respond with an SMS text message identifying a phone number of an interactive voice response (IVR) system for the cited party to call to provide his/her payment information. Once this payment information is provided, the processing of the payment of the citation may then proceed at step 130.

In the illustrated embodiment of FIG. 1, the payment is processed at step 130 by server 140 by charging the cited party's credit or debit card account either directly, or through an electronic toll payment account on payment server 150 linked to the cited party's credit or debit card. For example, the cited party may have an RFID transponder with an ID linked to the cited party's credit card, as is conventionally the case for RFID payment systems such as the EZPass system used on the East Coast of the United States. Upon confirmation of payment, the server 140 of the communications platform 125 may generate an SMS text message 135 back to the cited party at step 160 confirming receipt of payment for the citation. The server 140 also remits funds to the municipality 180 corresponding to the issuing authority ID at step 170 using RPPS, ACH, etc. message 145.

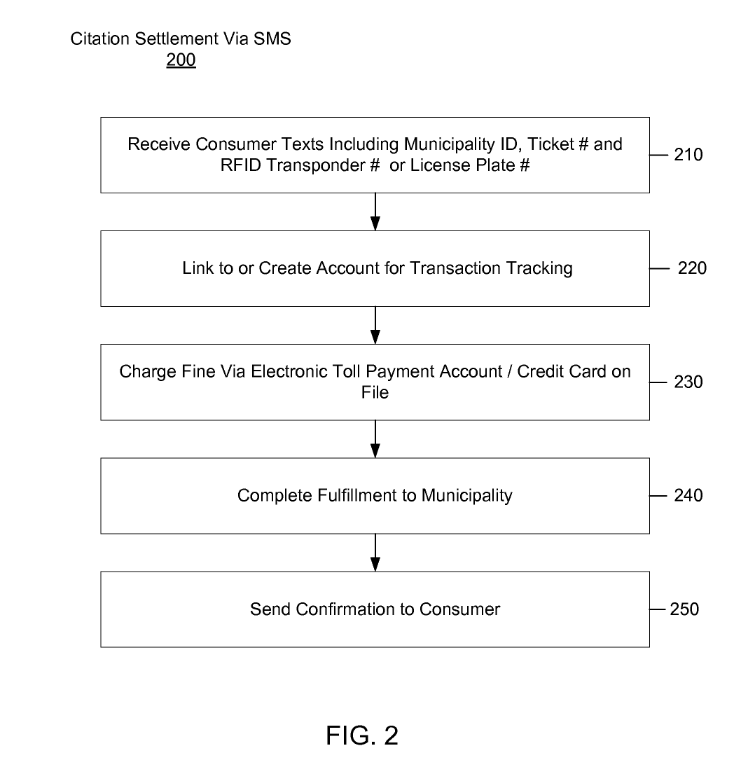

FIG. 2 illustrates an example embodiment of the method implemented by the server 140 of the communications platform 125 for enabling a person who has received a citation to attend to payment of any fines associated with the citation using SMS text messaging. In particular, server 140 includes a processor that is programmed by instructions stored in an instructions memory for implementing the method of FIG. 2. As illustrated in FIG. 2, the citation settlement method 200 includes the server 140 receiving texts at step 210 from the consumer (cited party) including the ID of the municipality (issuing authority), the citation (ticket) number, and the ID of the cited party's transponder (if one is used) and/or the cited party's license plate number. As noted above, the cited party may instead transmit other payment information or else send an SMS text message to a designated phone number that the cited party may call to handle payment. At step 220, the server 140 links the incoming SMS text message to an account for transaction tracking or, if no account exists for the cited party, an account is created for transaction tracking. The server 140 then instructs payment server 150 at step 230 to attend to payment of the fine by using the electronic toll payment account to charge a credit or debit card on file with the electronic toll payment entity. Upon receipt of payment confirmation from payment server 150, server 140 completes fulfillment to the municipality at step 240 and sends payment confirmation to the consumer (cited party) at step 250.

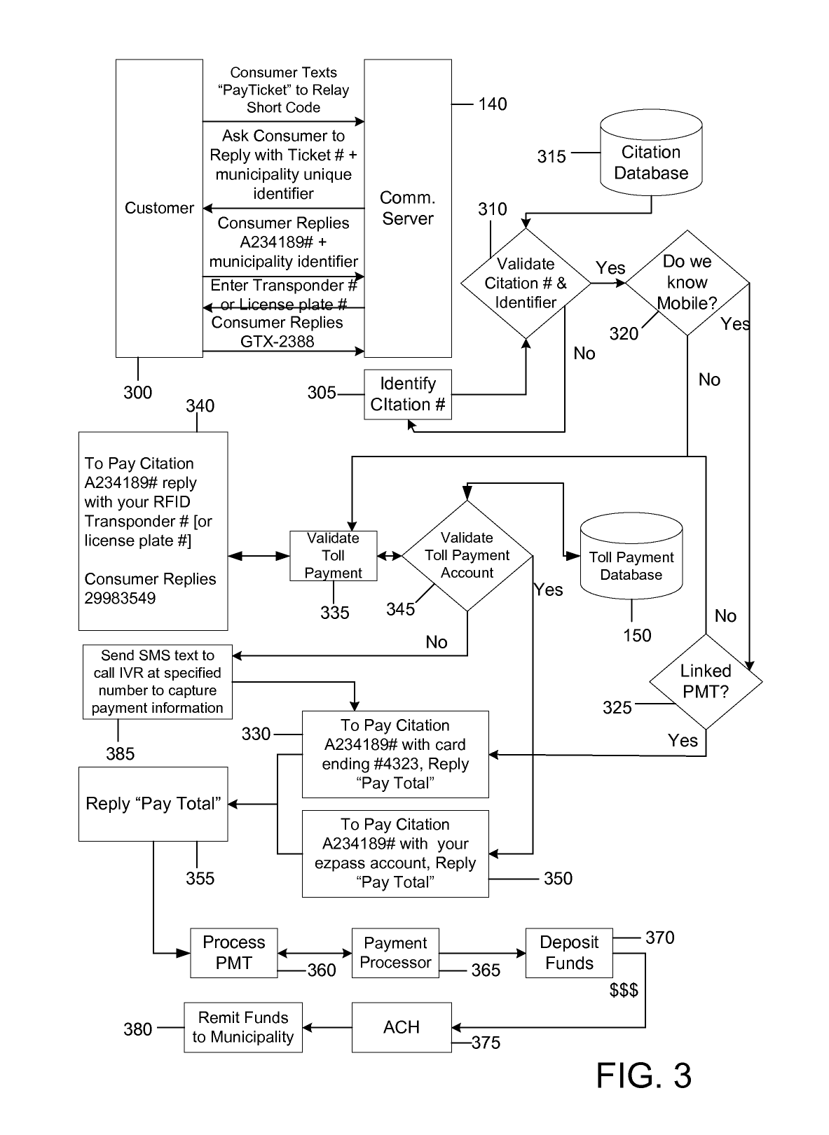

FIG. 3 illustrates the operation of the embodiment of FIGS. 1 and 2 in more detail, including payment of the municipality that issued the citation. As illustrated in FIG. 3, the consumer (cited party) initiates payment of a citation by SMS texting “Pay Ticket” to a Short Code of the server 140 of the communications platform 125. The server 140 responds by sending an SMS text message asking the consumer to reply with the citation (ticket) number and the unique ID of the issuing authority that issued the citation. The consumer then replies with an SMS text message including the ticket number and municipality identifier. The server 140 next responds by sending an SMS text message asking the user to enter his/her license plate number and/or RFID transponder number, and the consumer then replies by SMS texting his/her license plate number to the server 140. It will be appreciated that the license plate number is not strictly required for payment as a transponder ID, if available, may be used to link the citation to the consumer's electronic toll payment account.

Once the citation data has been entered, the software of server 140 identifies the citation number at 305 and validates the citation number and municipality identifier against a citation database 315 at step 310. If no match is found, the process is repeated. However, if the citation is found in the citation database 315, then the server 140 determines if the mobile number of the consumer is known at step 320. The mobile number of the consumer will likely be known as it may be taken from the received SMS text messages. In such case, the server 140 determines at step 325 whether the consumer's mobile number is linked to a payment account. If so, the server 140 may proceed to step 330 to attend to payment of the identified citation with the payment information (e.g., credit or debit card numbers) on file. However, if no linked payment information is available at step 325, then the server 140 validates that a toll payment RFID account is available at step 335 and attends to payment of the identified citation using the account information linked to the consumer's RFID transponder number and/or license plate number. The consumer replies with the transponder ID (or license plate number) and the toll payment account is validated against the toll payment database 150 at step 345. However, if the toll payment account cannot be validated at step 345, then an SMS text message is sent to the consumer at step 385 instructing the consumer to call an integrated voice response system for capture of payment information (such as a current credit or debit card account). Once the payment mechanism is validated, the identified citation is paid at step 330 or 350 with the identified payment mechanism (e.g., credit card linked to the toll payment RFID transponder). Once payment has been made, a Reply 355 may be sent to the consumer instructing him/her to “Pay Total.” Upon confirmation from the consumer, the payment is processed at 360 by payment processor 365 and the appropriate funds are deposited in the municipality's account at step 370. An electronic payment message, such as RPPS or ACH 375 is then provided to the municipality for remitting funds to the municipality at 380. Typically, a processing fee is also charged with the payment and the processing fee is retained by the entity providing the payment and/or communications service.

Those skilled in the art will appreciate that the computing environment of communications platform 125 may be a computer, a mainframe, a server (e.g., server 140), or the like. According to an example embodiment, the computing environment may include hardware components and/or software components such that the computing environment may be used to execute applications such as internet applications, operating systems, server applications, client applications, database applications, or the like. For example, the computing environment may be used to implement the systems and methods of FIGS. 1-3.

In an example embodiment, the computing environment may further include a processor that may be in operative communication with an instruction memory (both not shown) and instructed by an operating system to execute application programs for implementing the methods described above with respect to FIGS. 1-3. The processor may include a standardized processor, a specialized processor, a microprocessor, or the like. The processor may execute instructions including, for example, instructions for sending and receiving SMS text messages, validating information against a database, initiating payment transactions, and performing RPPS and/or ACH communications with a municipality. The instruction memory may include a computer readable storage medium in the form of volatile and/or nonvolatile memory such as random access memory (RAM), read only memory (ROM), cache, Flash memory, a hard disk, or any other suitable storage component. In one embodiment, the instruction memory may be a separate component in communication with the computing environment and the processor. According to another embodiment, the instruction memory may be integrated into the processor.

Those skilled in the art also will readily appreciate that many additional modifications are possible in the exemplary embodiment without materially departing from the novel teachings and advantages of the invention. Accordingly, any such modifications are intended to be included within the scope of this invention as defined by the following exemplary claims.

What is claimed:

1. A method of paying citations via SMS text messaging, comprising:
receiving an SMS text from a customer, said SMS text including a citation number, a unique identifier for the municipality that issued the citation, and payment identifying information;
charging a percentage of the amount of the citation to an account corresponding to the payment identifying information; and
transferring payment of the percentage of the citation amount to the municipality identified by the unique identifier.

2. A method as in claim 1, wherein the payment identifying information comprises an RFID transponder number and/or a license plate number for the customer, and the RFID transponder number and/or license plate number is/are linked to a credit or debit account for the customer.

3. A method as in claim 1, further comprising sending confirmation of payment of the citation to the customer via an SMS text message.

4. A method as in claim 1, further comprising validating the citation number and municipality unique identifier against a citation database.

5. A method as in claim 1, wherein the percentage of the citation amount is less than 100%.

6. A method as in claim 1, further comprising extracting a processing fee for processing payment of the citation.

7. A server programmed to enable payment of citations via SMS text messaging, said server including a processor that processes instructions for implementing the steps of:
receiving an SMS text from a customer, said SMS text including a citation number, a unique identifier for the municipality that issued the citation, and payment identifying information;
charging a percentage of the amount of the citation to an account corresponding to the payment identifying information; and
transferring payment of the percentage of the citation amount to the municipality identified by the unique identifier.

8. A server as in claim 7, wherein the payment identifying information comprises an RFID transponder number and/or a license plate number for the customer, and the RFID transponder number and/or license plate number is/are linked to a credit or debit account for the customer.

9. A server as in claim 7, further programmed to send confirmation of payment of the citation to the customer via an SMS text message.

10. A server as in claim 7, further programmed to validate the citation number and municipality unique identifier against a citation database.

11. A server as in claim 7, wherein the percentage of the citation amount is less than 100%.

12. A server as in claim 7, further programmed to extract a processing fee for processing payment of the citation.
